(19) United States
(12) Patent Application Publication
(10) Pub. No.: US 2013/0213917 A1
(43) Pub. Date: Aug. 22, 2013

(54) SET OF ACCESSORIES WITH SUPPORTS TO EXERCISE THE HUMAN BODY AND STRUCTURES WHERE THEY ARE SUPPORTED

(71) Applicant: Manuel Jesús Rios Garcia Prieto, Zapopan (MX)

(72) Inventor: Manuel Jesús Rios Garcia Prieto, Zapopan (MX)

(73) Assignee: Manuel Jesús RIOS GARCIA PRIETO, Zapopan, Jalisco (MX)

(21) Appl. No.: 13/879,955

(22) PCT Filed: Oct. 10, 2011
(86) PCT No.: PCT/MX2011/000122

§ 371 Date: Apr. 17, 2013

(30) Foreign Application Priority Data
Oct. 19, 2010 (MX) MX/A/2010/011483

(51) Int. Cl. F16B 7/04

(52) U.S. Cl. CPC F16B 7/044
USPC 211/182

(57) ABSTRACT

Described herein is a set of accessories and corresponding supports for exercising the human body, same which in its most basic modality requires minimum space, and when not in use, it can hardly be seen by the naked eye. Because of its design, the apparatus is assembled and disassembled in a matter of seconds without the need of tools. In aforementioned most basic modality, up to four persons can simultaneously exercise and therefore it is a solution for all those who wish to have a mean to exercise the body at home, but lack of sufficient space. The apparatus adapts to different locations, conditions and circumstances, either indoors, outdoors, home, office, etc.

### TECHNICAL FIELD

Herein described invention will have respective field of application in physical personal maintenance, specifically to exercise human body and consequently to achieve a better general physical condition.

### BACKGROUND

Today, there are endless numbers of different types of devices to exercise the human body, however, from inventor's point of view, they all have a series of disadvantages that are herein subsequently described:

All types of universal devices which relay on “dead weight” plates and pulleys or free weights, either bars and/or dumbbells which offer different ways and positions to exercise most of human body muscles are often large, heavy, cumbersome and costly, and require large spaces both for use as well as storage. Additionally, all of them incorporate a variety of moving parts and pieces such as cables, pulleys, clamps, bearings, nuts, screws, washers, plates and/or heavy metal disks, etc., and which in their majority do require some type of maintenance, starting with cleaning, since at it happens with any stationary object, they are excellent dust accumulators. Likewise, there is a constant need to adjust, tighten, loosen, lubricate or grease some of the pieces or parts, since when they are used they often become loose, separated or may even turn rusty because some of them are metal made.

On the other hand, there are also technical aspects for every exercise as well as the correct and incorrect way to do them.

Exercising the human body by means of its own weight and/or through dynamic tension, significantly minimizes the risks of getting hurt, in comparison to any exercise type which is performed by using dead weight, as in the case of free weights and/or pulleys devices with dead weight plates.

In the case of free weights and pulleys devices with dead weight plates, there are also certain disadvantages such as having to stop or interrupt a series of exercises to increase or decrease the weight with which work is being done, and in some cases this involves having to stop or interrupt a series of exercises and also having to get up and leave respective exercise position in which a person already was to increase or decrease the weight with which work is being carried out. In both scenarios, this usually happens and regarding free weights, this happens one hundred percent of the time.

Concerning time, one of the main reasons why people cannot practice any type of sport or exercise is firstly the time factor, followed by financial factor, since any type of sport generates costs. Regarding gyms, this implies paying month to month and year after year, memberships that as time goes by become more costly and inaccessible for most people. As far as the inventor is concerned, these two reasons have made him stop going to a gym for the last forty years.

### SUMMARY

An advantage to the invention is to provide a dynamic exerciser for the human body which does not require space, is nearly undetectable to the naked eye, effective and of high performance, at very accessible and much lower cost than others of its sort, adaptable to different locations, conditions and circumstances, both indoors and/or outdoors, inside and outside home, office, etc. Inventor's dedication to the practice of physical exercise and respective concern to achieve a good mental and physical state by way of said activity has led him throughout his life to analyze different devices and methods to exercise the body.

The physical structure of the apparatus described herein is not limited to a specific material nor to gender, age or size and accounts for its own case for respective components, and incorporates: bicycle, two-ways adjustable parallel bars, swivel ratchets for different exercises such as dips and push ups at different angles and heights as well as three-ways adjustable roman chair, crunches bar and table, quadriceps seat, ankles attachment harness for inverted crunches, concave supports and multi-purpose supports as combined with resistance bands to exercise limbs, etc.

To have a room spacious enough within the comfort of home specifically designed to exercise body, is without any doubt, a luxury and a great advantage that most people cannot afford. After carefully considering the most relevant disadvantages regarding aforementioned devices as well as the lack of time and/or financial resources, inventor experimented for several years with different methods, and finally designed a human body exerciser, which due to its own characteristics provides another option and solution to stated problems and disadvantages, being aforementioned characteristics described as follows:

A dynamic exerciser for the human body which does not require space, is nearly undetectable to the naked eye, effective and of high performance, at very accessible and much lower cost than others of its sort, adaptable to different locations, conditions and circumstances, both indoors and/or outdoors, inside and outside home, office, etc.

### DETAILED DESCRIPTION OF VARIOUS EMBODIMENTS

Characteristic details of this innovative human body dynamic exerciser are clearly illustrated in the following description along with accompanying drawings, as well as reference signs to indicate shown parts and figures.

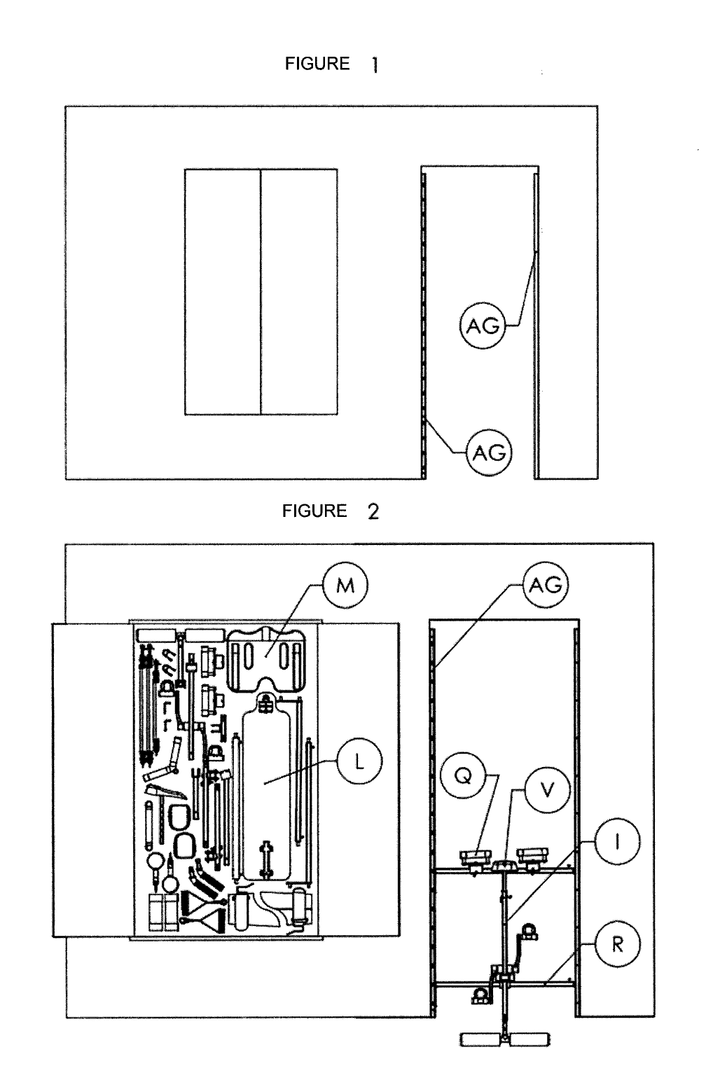

FIG. 1, is a front view of a set of accessories module with supports to exercise human body with vertical square posts installed.

FIG. 2, is a front view of a set of accessories module with supports in order to exercise human body with vertical square posts installed, with some accessories attached.

FIG. 3, is a perspective view of a set of accessories module with supports to exercise human body along with angled vertical posts installed and different approaches to respective structures.

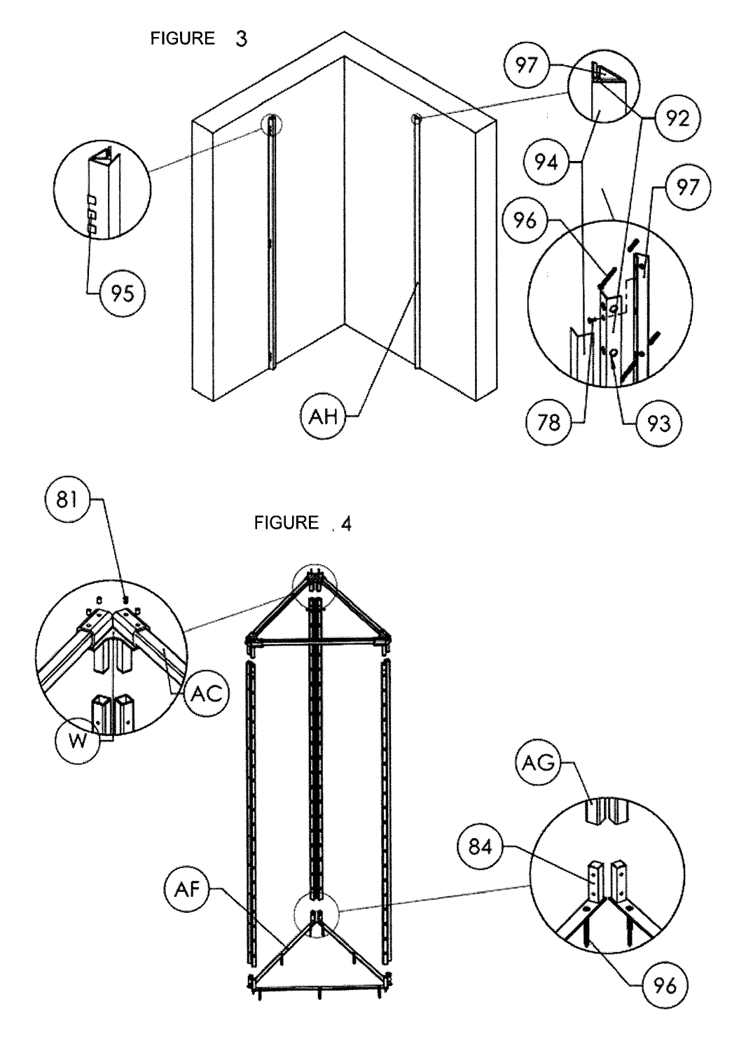

FIG. 4, is a perspective expanded detailed view of assembled triangular structure.

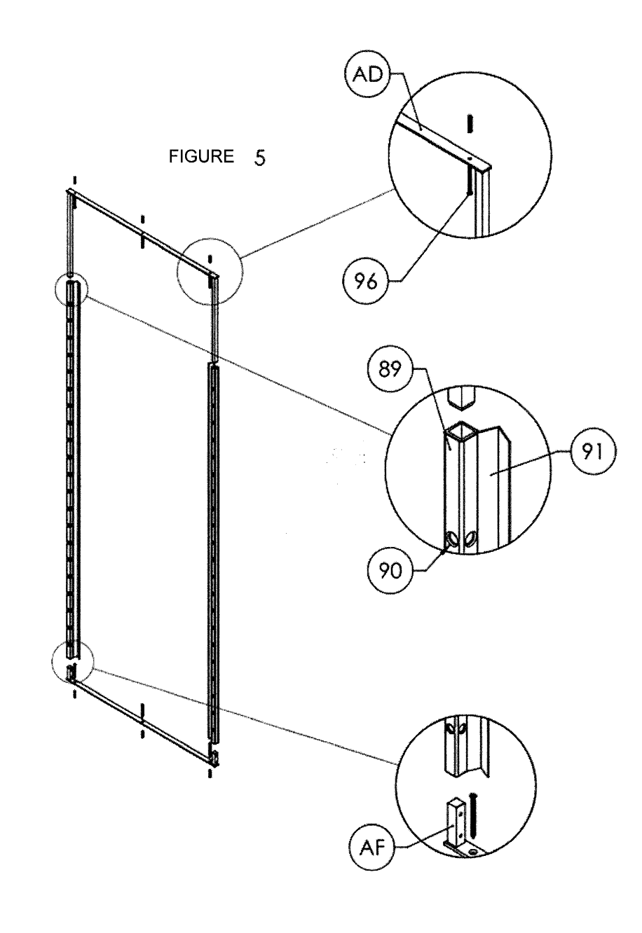

FIG. 5, is a perspective expanded detailed view of the structure with square vertical posts as installed from floor to ceiling by means of base AF to floor and base AD to ceiling.

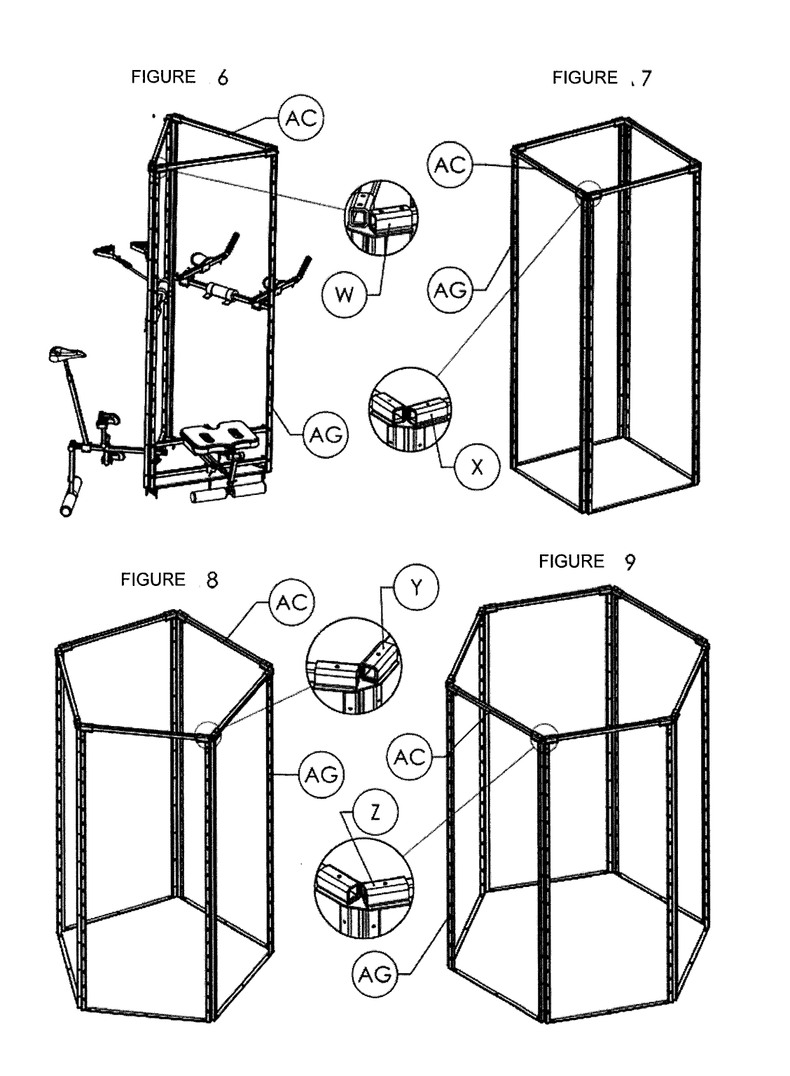

FIG. 6, is a perspective view of triangular structure assembled with some accessories installed.

FIG. 7, is a perspective view of the square structure assembled.

FIG. 8, is a perspective view of pentagonal structure assembled.

FIG. 9, is a perspective view of hexagonal structure assembled.

FIG. 10, is a perspective view of octagonal structure assembled, with some accessories installed.

FIG. 11, is a perspective view of fixed support A.

FIG. 12, is a perspective view of swivel support B.

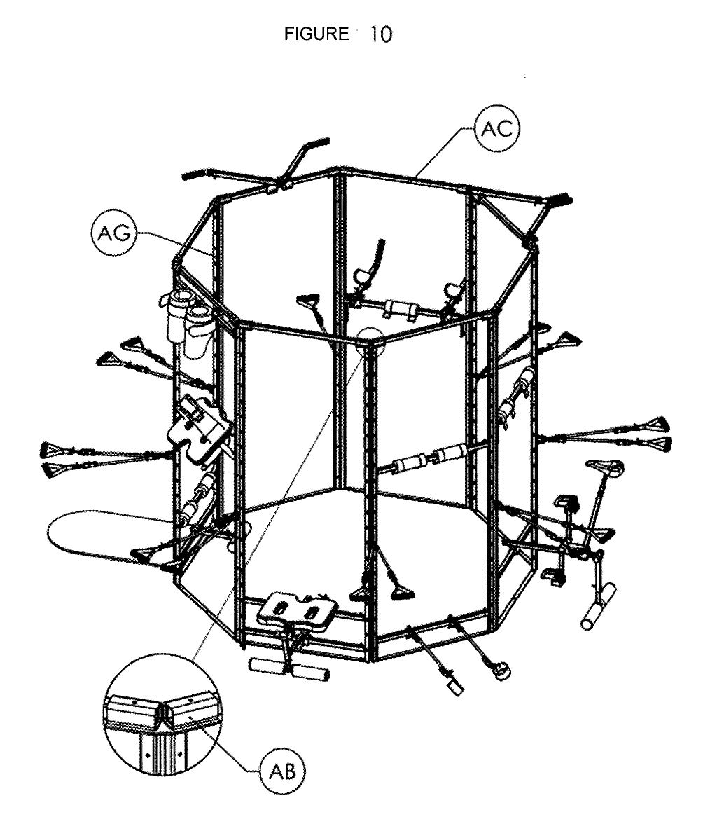

FIG. 13, is a perspective view of support with stops C.

FIG. 14, is a perspective view of vertical support D.

FIG. 15, is a perspective view of resistance bands support E

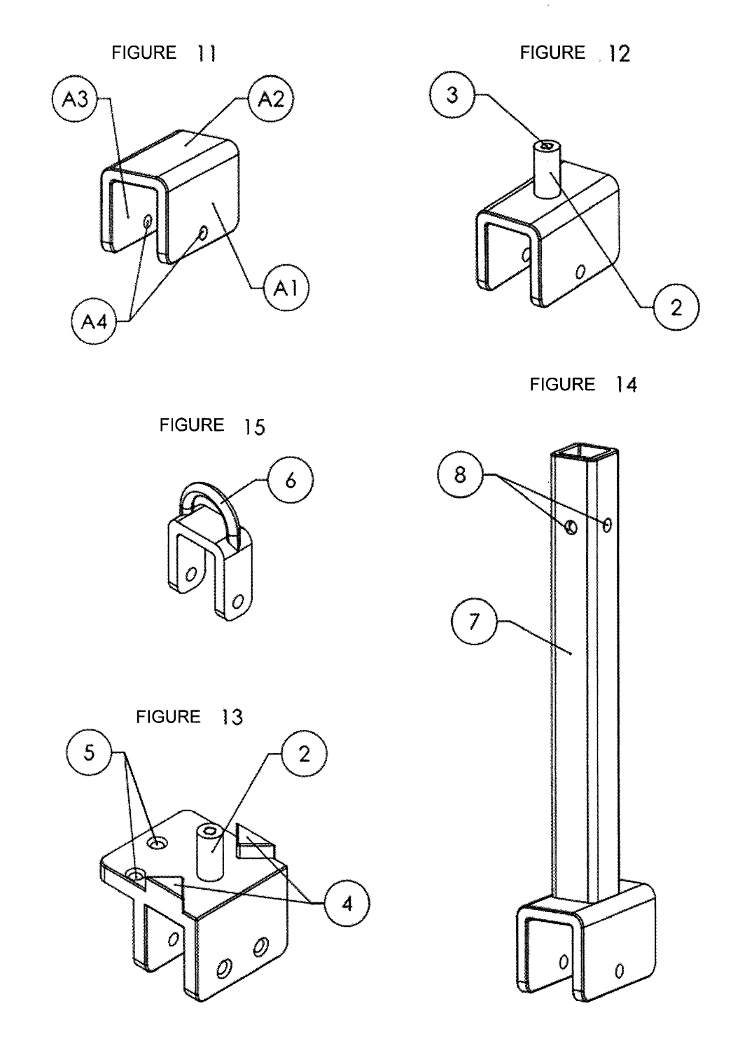

FIG. 16, is a perspective view of horizontal support F.

FIG. 17, is a perspective view of fixed lever G.

FIG. 18, is a perspective view of swivel lever H.

FIG. 19, is a perspective view of tilted support I.

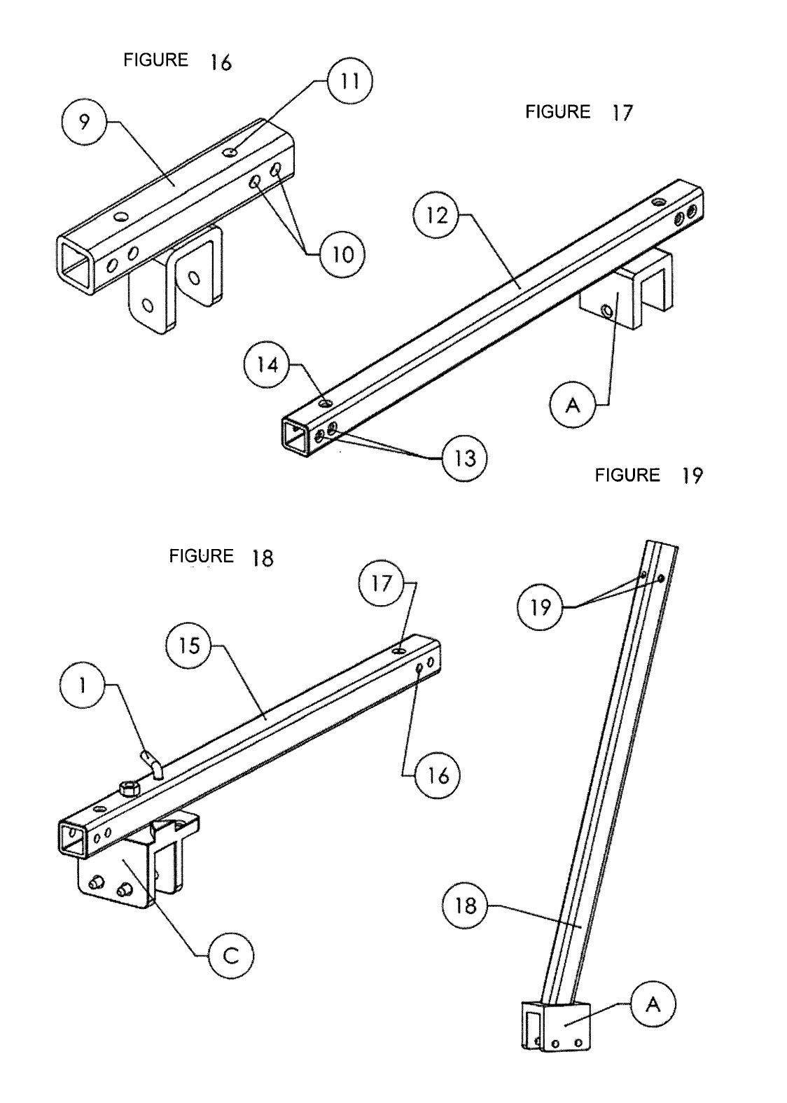

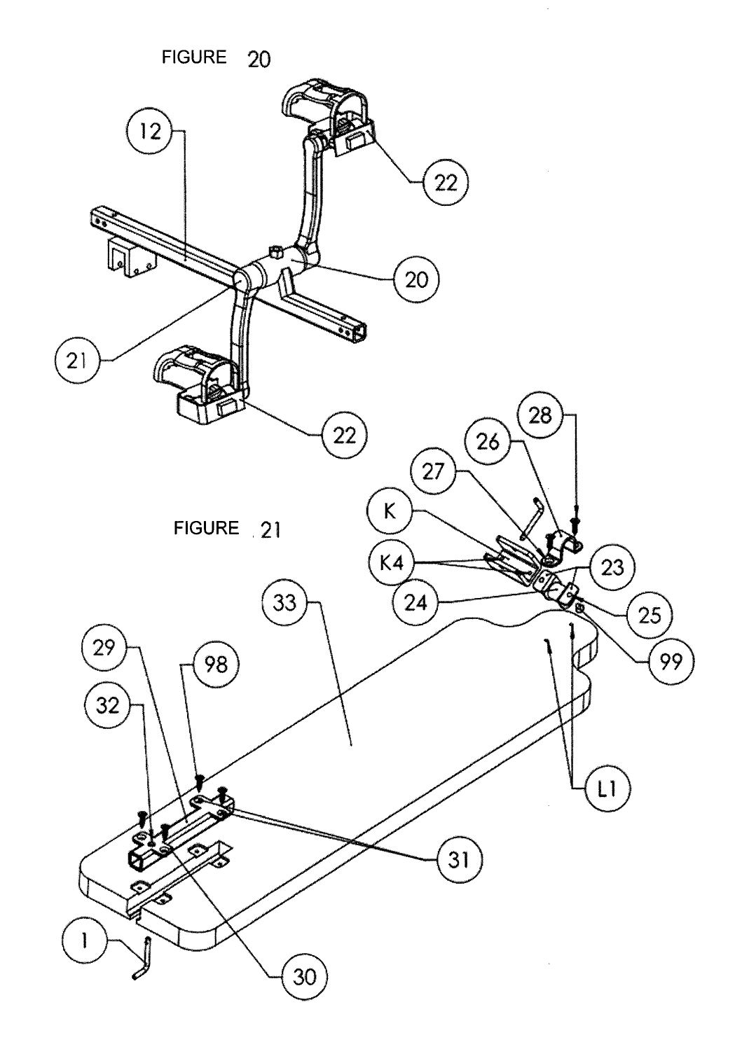

FIG. 20, is a perspective view of foot pedals support J.

FIG. 21, is a perspective detailed view of base L.

FIG. 22, is a perspective view of base M.

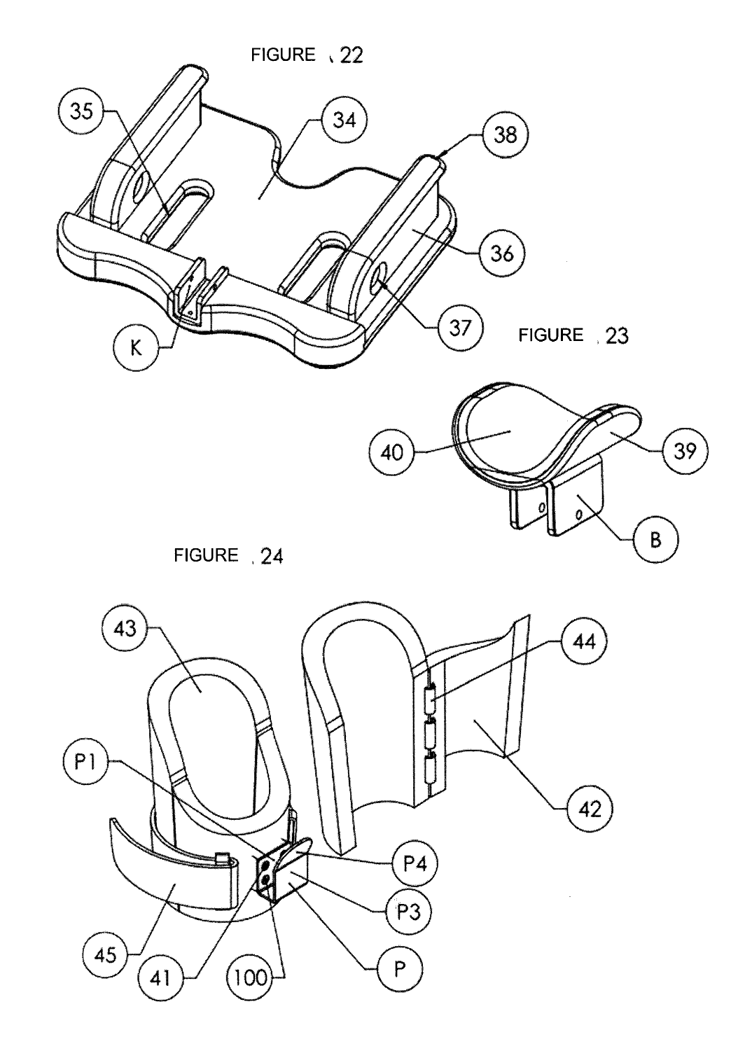

FIG. 23, is a perspective view of concave support N.

FIG. 24, is a perspective view of ankles attachment harness O, one opened and another closed.

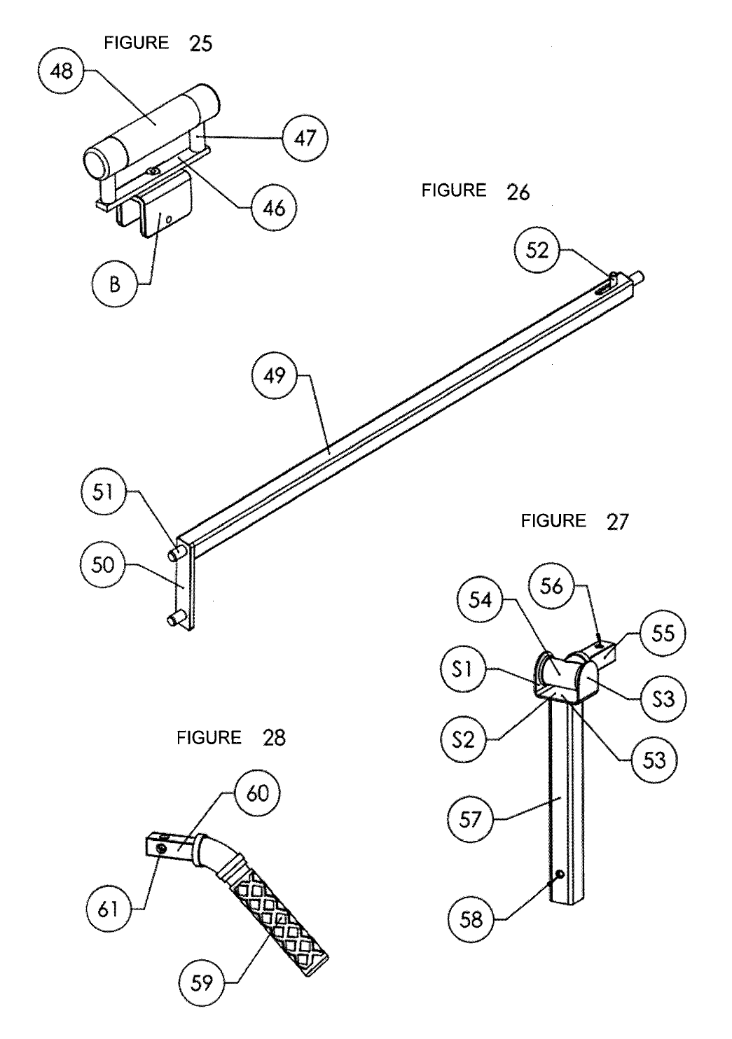

FIG. 25, is a perspective view of a rotating hand grip Q.

FIG. 26, is a perspective view for supports bar R.

FIG. 27, is a perspective view of hinged support S.

FIG. 28, is a perspective view of U angled handle.

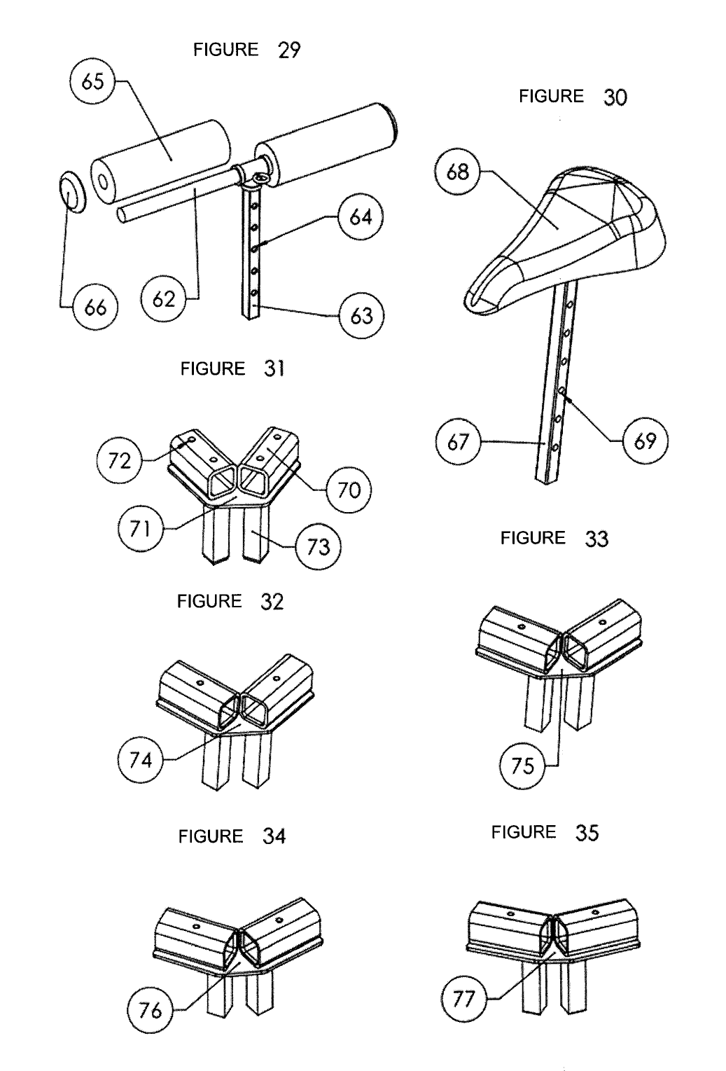

FIG. 29, is a perspective detailed view of “T” multi-purpose support.

FIG. 30, is a perspective view of bike seat V.

FIG. 31, is a perspective view of 60° joint fitting W.

FIG. 32, is a perspective view of 90° joint fitting X.

FIG. 33, is a perspective view of 108° joint fitting Y.

FIG. 34, is a perspective view of 120° joint fitting Z.

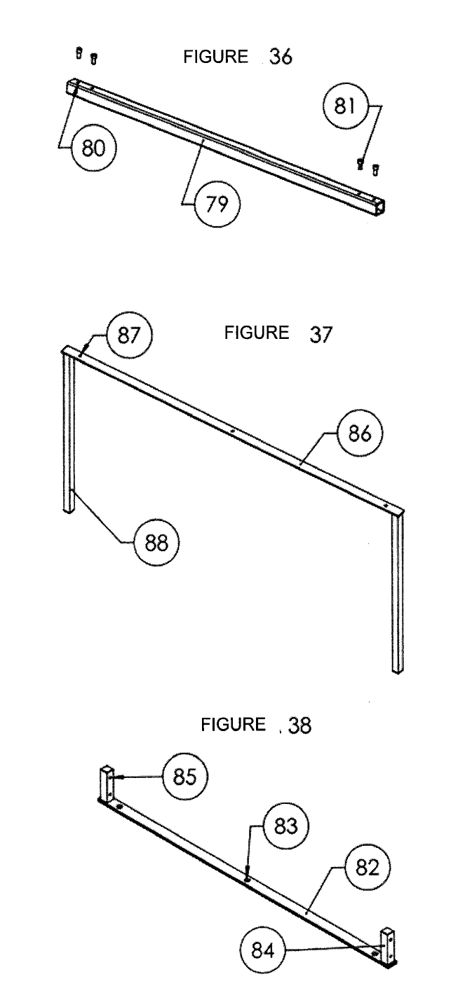

FIG. 35, is a perspective view of 135° joint fitting AB.

FIG. 36, is a perspective view of union bars for polygonal modules AC.

FIG. 37 is a perspective view of base AD for ceiling attachment.

FIG. 38 is a perspective view of base AF for floor attachment.

The following description will point out in detail each of the individual components and the way they interact with each other: supports, accessories and structures in order for invention understanding to be clear.

### Supports

Supports as used for accessories can have the following variables:

Fixed support A (FIG. 11), which consists of a set of three plates, A1, A2, A3 that are continuously arranged forming a square “U” since the end of the first A1 continues with the start of the second A2, creating 90° angles and the third A3, is located at the end of the second, thus creating the same angle; the first A1 and the third A3 plates, located at opposite ends to plate A2 in respective centered side surface, incorporate at least one hole A4, through which a pin 1 goes through; furthermore, over plate A2 located are: other supports (vertical D or horizontal F) or those accessories to which implemented is fixed support A.

Swivel support B (FIG. 12), accounts for the same features as fixed support A, nevertheless plate A2 incorporates a pivot 2 over which accessories that are placed in swivel support B spin. In turn, aforementioned pivot has a threaded hole 3.

Support with stops C (FIG. 13), accounts for the same features as swivel support B, nevertheless, in plate A2 there is at least one stop 4, where upon accessories being spun using pivot 2 and plate A2, there is at least one hole 5 which in turn allows using a second pin 1 in order to secure the same accessory as used by described support.

Vertical support D (FIG. 14), accounts for all those features contained in fixed support A, nevertheless, in plate A2 there is a perpendicular stem 7 fixed to said plate, and on stem 7 opposite end there is at least one hole 8 on each face.

Resistance bands support E (FIG. 15), accounts for all those features as contained in fixed support A, nevertheless, in plate A2 there is a fixed semicircular arch 6, over which other conventional accessories are attached, such as resistance bands, ropes, etc.

Horizontal support F (FIG. 16), accounts for all those features as contained in fixed support A, nevertheless, in plate A2 there is a horizontal stem 9 fixed to said plate and has at least one pass-through hole 10 on vertical opposed faces and at least one pass-through hole 11 on parallel face to plate A2.

Fixed support K (FIG. 21) accounts for all those features as contained in fixed support A, nevertheless, in plate A2 there are two holes K4, one on each end of plate A2.

### Accessories

Fixed lever G (FIG. 17), on a plate A2 of a fixed support A, placed is a fixed square section profile 12, in displaced position, both horizontal as well as perpendicular to said fixed support A, same which has on both ends at least two pass-through holes 13 in horizontal position and with at least one pass-through hole 14 in vertical position.

Swivel lever H (FIG. 18), on a support with stops C, placed is on a horizontal square section profile 15 and is rotated by way of pivot 2, said square section 15 incorporates in both ends at least two pass-through holes 16 in horizontal position and at least one pass-through hole 17 in vertical position, and these are secured with a conventional pin 1.

Tilted support I (FIG. 19), accounts for all those features as contained in fixed support A, nevertheless, in plate A2 there is a fixed tilted stem 18 with a 75° angle with respect to plate A2, and said tilted stem 18, on opposite end to fixed support A bracket, has at least one hole 19 on each face.

Foot pedals support J (FIG. 20), on fixed lever G attached to horizontal stem opposite second half 12, is a transversal circular section 20 over which placed is an axle 21, with conventional bicycle foot pedals 22.

Base L (FIG. 21), over fixed support K, placed is a hinged mechanism comprised by a pair of angle pieces 23 as opposed between them, and whose parallel walls are joined by way of a round bar section 24, and said pieces in angle 23 incorporate on respective collinear faces a centered hole 25 which matches holes K4 that in turn serve to hold by mean of screws 99 to fixed support K; on round section bar 24 placed is a hinged plate 26 comprised by three plates as arranged according to “Omega” letter shape, this is “Ω” and each of the collinear sections to said hinged plate 26 has a centered hole 27 and matches holes L1, which in turn serve to hold by way of screws 28 to base 33; on the opposite end of base 33, there is a square profile 29 that in one of its faces has at least two plates 30 which are arranged according to a transversal shape, and the latter have one hole 31 each and are used to join or secure by way of some fastening mean 98 (for example: screw, latch, weld, glue, lag screw, etc.) profile 29 to base 33. Said square profile 29 additionally incorporates a hole 32 which passes through it from side to side and where placed is a second pin 1.

Base M (FIG. 22), on a fixed support K placed is a base 34, with said support located underneath and on the front portion of said base, and additionally, base 34 incorporates two rectangular holes 35 equidistant with respect to base center and has two lower crossbars 36 parallel to rectangular holes 35 which are centered between the latter and edge of base 34, crossbars 36 are phased out regarding base 34 transversal center and have a pass-through hole 37 which matches said center; toward base 34 front area, crossbars 36 have a parallel protrusion 38 which is used to be placed on a bar for supports R.

Concave support N (FIG. 23), over a swivel support B, placed is a concave shape base 39, which in turn is pierced through its center and joined to swivel support B by way of pivot 2. Said concave shape base 39, incorporates a padded lining 40 on respective inner face.

Ankles attachment harness O (FIG. 24) on a fixed support P (FIG. 24), which has the same features as fixed support A, on plate P1 there are at least two holes 41 for fastening purposes by way of screws 100 and at the end of plate P3 assembly continues with the start of plate P4 as arranged at an angle towards the outer section of such support; end of plate P4 incorporates rounded corners. Aforementioned fixed support P is joined on middle portion to a semicircular section concave first piece 42 which has perpendicular crossing slices to said section; and in turn this is joined to another semicircular section concave piece 43, by way of a hinge system 44 as well as a closing system for both semicircular concave sections which in turn are adjustable through a strap or belt 45. With both semicircular pieces closed, piece 43 has a curve slice which starts as of concave piece 42 perpendicular section, which in turn is of a larger size.

Rotating hand grip Q (FIG. 25), on a swivel support B, placed is a plate 46 as pierced through its center using pivot 2, and on said plate 46 ends, the upper section has two posts 47 parallel between them and perpendicular to plate 46, said posts 47 are joined on the upper portion by way of a hand grip 48.

Supports bar R (FIG. 26), comprised by crossbar 49 which in turn in one of its ends has a lever 50, perpendicular to crossbar 49 and on opposite side to respective joint with aforementioned crossbar there are at least two protruding areas 51; to prevent respective spinning on opposite end to crossbar 49 there is a retractable device 52 to be placed indistinctly on vertical posts AG (FIG. 2) or in angled posts AH (FIG. 3) and additionally on this bar placed are different accessories using different supports.

Hinged support S (FIG. 27), on a fixed support 53, which consists of a set of three plates S1, S2, S3 as continuously arranged creating a square “U” shape, due to the fact that the end of the first S1 continues with the start of the second S2 creating 90° angles, and the third S3 is located at the end of the second also creating the same angle; such hinged support S, consists of a round section bar 54 which joins with the inner faces of plates S1 and S3; over said round section bar 54 a square section bar 55 rotates, that in turn has a transverse hole 56 at the opposite end of respective joint with round section profile 54, in which a conventional pin 1 is placed. On the outer face of plate S2 there is a perpendicularly joined square section profile 57, where at the opposite end to joint with plate S2, and by way of a pass-through hole 58 that crosses two profile opposite faces and through said hole 58, a conventional pin 1 is placed; this hinged support S, is indistinctively used with the following accessories: Foot pedals support J, (FIG. 20) Horizontal support F (FIG. 16) or Base L (FIG. 21).

“T” multipurpose support (FIG. 29), it has a round bar 62 which is joined to a square section bar 63 and both parts create a “T”, and said square bar 63 has at least two holes 64 which are equidistant, centered and lengthwise arranged; each of the ends of said round bar 62 incorporates a bearing 65 and a cap 66 which creates a stop with round bar 62, this “T” multipurpose support is indistinctively introduced at one end of vertical support D, horizontal support F or hinged support S.

U angled handle (FIG. 28), it is conformed by an angled hand grip 59 at 135° and joined on one end to a square section 60, same which on one of its ends incorporates a centered hole 61 on each face of section 60, and this U angled handle is indistinctively joined to a horizontal support F (FIG. 16), fixed lever G (FIG. 17) or a swivel lever H (FIG. 18), using a conventional pin 1.

V seat (FIG. 30), on a tilted support I placed is a bar 67 by way of “male-female engagement” system and on opposed end, aforementioned bar 67 has a conventional bicycle seat 68; said bar has at least two centered and equidistant holes 69 as arranged on one of its faces which in turn cross two of its faces and a conventional pin 1 is used to adjust height, by way of tilted stem 18.

### Structures

Joint fitting W (FIG. 31), which is comprised by one plate 71 that incorporates two couplings 70 on respective top face, positioned at a 60° angle among longitudinal axes; said couplings 70 have at least two holes 72 also on respective top surface, and aforementioned base 71 has two posts 73 as perpendicularly positioned on corresponding bottom face, same which are inserted on the top portion of vertical posts AG for triangular polygonal structure assembly.

Joint fitting X (FIG. 32), incorporates the features of joint fitting W, nevertheless, the angle at which couplings 70 are positioned is of 90° among respective longitudinal axes

Joint fitting Y (FIG. 33), incorporates the features of joint fitting W, nevertheless the angle at which couplings 70 are positioned is of 108°

Joint fitting Z (FIG. 34), incorporates the features of joint fitting W, nevertheless the angle at which couplings 70 are positioned is of 120° among respective longitudinal axes

Joint fitting AB (FIG. 35), incorporates the features of joint fitting W, nevertheless the angle at which couplings 70 are positioned is of 135° among respective longitudinal axes

Described joint fittings (W, X, Y, Z and AB) are the most common ones, preferentially for regular polygonal structures, nevertheless, it must be pointed out that such examples are of an including, but not limited to, nature; specially when created structures are irregular polygons.

AC bar (FIG. 36), is conformed by a square section profile 79 same which on each of its ends has at least two threaded holes 80 on respective faces and said bar 79 allows engaging joint fittings (W, X, Y, Z and AB) by way of screws 81 for polygonal structures assembly.

Base AF (FIG. 38), comprised by a rectangular section bar 82, which has at least two holes 83 and on each of its ends incorporates a square section post 84 which is placed in vertical position on respective top face; said square section post 84 also has at least two threaded holes 85, which are centered and lengthwise arranged in horizontal position

Base AD (FIG. 37), comprised by a rectangular section bar 86, which has at least two holes 87 and on each of its ends incorporates a square section post 88 which is placed in vertical position on respective top face; said square section posts 88 are inserted through the top portion to vertical posts AG and subsequently aforementioned base AD is attached to ceiling by means of screws 96

Vertical post AG (FIG. 5) is comprised by a square section profile 89 same which has at least four holes 90 as centered, equidistant and lengthwise arranged on at least three of its faces. Joined to said vertical profile 89, there is at least one cover profile 91, which allows hiding aforementioned holes 90.

Angled vertical post AH (FIG. 3), is comprised by a straight angle section profile 92, same which has at least four pass-through holes 93 that are centered, equidistant and lengthwise arranged on its two faces; said angled vertical post AH also has an angled profile base 97, to which it is attached by way of screws 78, and in turn, angled profile base 97 is secured to wall by way of screws 96, and said straight angle profile 92 has in turn a cover profile 94, which allows hiding pass-through holes 93 on both faces; both in square vertical post AG as well as angled vertical post AH, cover profiles 91 and 94 are joined to respective vertical profiles 89 and 92 by way of hinges 95.

### Invention's Operation

Polygonal structures AJ assembly. Base AF is fixed to floor by using at least two screws 96, on posts 84, and on said first posts, assembled are vertical posts AG and on the top portion inserted are joint fittings (W, X, Y, Z and AB) according to intended to be assembled polygon, and for joining and creating polygonal structures AJ, perpendicular posts 73 are introduced on vertical posts AG, fastening both parts with screws 81; subsequently, on couplings 70 assembled are polygonal joint fittings AC union bars using screws 81 to secure them.

Floor-ceiling structures AK assembly. Fastening on lower portion is the same as for polygonal structures AJ assembly and on the upper portion, fastening base AD is assembled and secured to ceiling by using screws 96.

I claim:

1. A structure to hold exercise accessories of:
at least one bar for accessories intended to exercise the human body;
at least two square or angled vertical posts where horizontally assembled are bars for said accessories;
at least two joint fittings in order to join vertical posts, with an upper bar and a bottom base which holds vertical posts and joins them with bars using aforementioned joint fittings, thus creating regular or irregular polygons edges;

2. The structure of claim 1 is characterized by accessories incorporate means or mechanisms to be engaged in said structure bar;

3. The structure of claim 1 is characterized by joint fittings as used to join said structures incorporate angles between 1° and 359°, being the most common 60°, 90°, 108°, 120° and 135°;

4. The structure of claim 1 is characterized by respective vertical posts are comprised by a square section profile 89 which has at least four holes 90 that are centered, equidistant and lengthwise arranged on at least three of its faces. Joined to said vertical profile 89, there is at least one cover profile 91, which allows hiding aforementioned holes 90; and angled vertical posts AH; which are comprised by a straight angle section profile 92, same which has at least four pass-through holes 93 that are centered, equidistant and lengthwise arranged on its two faces; said angled vertical post AH also has an angled profile base 97, to which it is attached by way of screws 78, and in turn, angled profile base 97 is secured to wall by way of screws 96, and said straight angle profile 92 has in turn a cover profile 94, which allows hiding pass-through holes 93 on both faces; both in square vertical post AG as well as angled vertical post AH, cover profiles 91 and 94 are joined to respective vertical profiles 89 and 92 by way of hinges 95;

5. A module to exercise the human body according to claim 1 comprising:
at least one accessory to exercise the human body, same which is placed over horizontal bar;

6. A module to exercise the human body according to claim 4 is characterized by of being possible to assemble it with other similar modules using respective joint fittings to join vertical posts;

7. A horizontal bar for a module according to claim 4 is characterized by in said bar supported is at least one accessory to exercise the human body;

8. A set of accessories to exercise the human body to be placed on modules' horizontal bars and previously described structures comprising:
a Fixed lever G over a fixed support A, where horizontal stem 12 extends on one of its sections in order to place over it different accessories or insert U angled handle;
a Swivel lever H on a support with stops C, is placed on a horizontal square section profile 15 and is rotated by way of pivot 2, said square section 15 incorporates in both ends at least two pass-through holes 16 in horizontal position and at least one pass-through hole 17 in vertical position, and these are secured with a conventional pin 1;
a Tilted support I, accounts for all those features as contained in fixed support A, nevertheless, in plate A2 there is a fixed tilted stem 18 with a 75° angle with respect to said plate, and such tilted stem 18, has at least one hole 19 on each face;
a Foot pedals support J, on fixed lever G as attached to horizontal stem opposite second half 12, is a transversal circular section 20 over which placed is an axle 21, with conventional bicycle foot pedals 22;
a Base L, over fixed support K, where placed is a hinged mechanism comprised by a pair of angle pieces 23 as opposed between them, and whose parallel walls are joined by way of a round bar section 24, and said pieces in angle 23 incorporate on respective collinear faces a centered hole 25 which matches holes K4 that in turn serve to hold by mean of screws 99 to fixed support K; on round section bar 24, a hinged plate 26 rotates, comprised by three plates as arranged according to “Omega” letter shape, this is “Ω” and each of the collinear sections to said hinged plate has a centered hole 27 and matches holes L1, which in turn serve to hold by way of screws 28 to base 33; on the opposite end of base 33, there is a square profile 29 that in one of its faces has at least two plates 30 which are arranged according to a transversal shape, and the latter have one hole 31 each and are used to join or secure by way of some fastening mean 98 (for example: screw, latch, weld, glue, lag screw, etc.) profile 29 to base 33. Said square profile 29 additionally incorporates a hole 32 which passes through it from side to side and where placed is a second pin 1;
a Base M, on a fixed support K, where placed is a base 34, with said support located underneath and on the front portion of said base, and additionally, base 34 incorporates two rectangular holes 35 equidistant with respect to base center and has two lower crossbars 36 parallel to rectangular holes 35 which are centered between the latter and edge of base 34, crossbars 36 are phased out regarding base 34 transversal center and have a pass-through hole 37 which matches said center; toward base 34 front area, crossbars 36 have a parallel protrusion 38 which is used to be placed on a bar for supports R;
a Concave support N over a swivel support B, where placed is a concave shape base 39, which in turn is pierced through its center and joined to swivel support B by way of pivot 2. Said concave shape base 39, incorporates a padded lining 40 on respective inner face;
an Ankles attachment harness O on a fixed support P, which has the same features as fixed support A, on plate P1 there are at least two holes 41 for fastening purposes by way of screws 100 and at the end of plate P3 assembly continues with the start of plate P4 as arranged at an angle towards the outer section of such support; end of plate P4 incorporates rounded corners. Aforementioned fixed support P is joined on middle portion to a semicircular section concave first piece 42 which has perpendicular crossing slices to said section; and in turn this is joined to another semicircular section concave piece 43, by way of a hinge system 44 as well as a closing system for both semicircular concave sections which in turn are adjustable through a strap or belt 45. With both semicircular pieces closed, piece 43 has a curve slice which starts as of concave piece 42 perpendicular section, which in turn is of a larger size;
a Rotating hand grip Q, on a swivel support B, where placed is a plate 46 as pierced through its center using pivot 2, and on said plate 46 ends, the upper section has two posts 47 parallel between them and perpendicular to plate 46, and on top ends, placed is a hand grip 48;
a Supports bar R as comprised by crossbar 49 which in turn in one of its ends has a lever 50, perpendicular to crossbar 49 and on opposite side to respective joint with aforementioned crossbar there are at least two protruding areas 51; to prevent respective spinning on opposite end to crossbar 49 there is a retractable device 52 to be placed indistinctly on vertical posts AG or in angled posts A11 and additionally on this bar placed are different accessories using different supports;
a Hinged support S, on a fixed support 53, which consists of a set of three plates S1, S2, S3 as continuously arranged creating a square “U” shape, due to the fact that the end of the first S1 continues with the start of the second S2 creating 90° angles, and the third S3 is located at the end of the second also creating the same angle; such hinged profile S, consists of a round section bar 54 which joins with the inner faces of plates S1 and S3; over said round section bar 54 a square section bar 55 rotates, that in turn has a transverse hole 56 at the opposite end of respective joint with round section profile 54, in which a conventional pin 1 is placed. On the outer face of plate S2 there is a perpendicularly joined square section profile 57, same which at the opposite end to joint with plate S2, and by way of a pass-through hole 58 that crosses two profile opposite faces and through said hole 58, a conventional pin 1 is placed; this hinged support S, is indistinctively used with the following accessories: Foot pedals support J, Fixed lever support G, Swivel lever support H, Base L;
a “T” multipurpose support, that has a round bar 62 which is joined to a square section bar 63 and both parts create a “T”, and said square bar 63 has at least two holes 64 which are equidistant, centered and lengthwise arranged; each of the ends of said round bar 62 incorporates a bearing 65 and a cap 66 which creates a stop with round bar 62, this “T” multipurpose support is indistinctively introduced at one end of vertical support D, horizontal support E or hinged support S, Fixed lever support G, Swivel lever support H;
an U angled handle, same which is conformed by an angled hand grip 59 at 135° and joined on one end to a square section 60, same which on one of its ends incorporates a centered hole 61 on each face of section 60, and this U angled handle is indistinctively joined to a fixed lever support G, or a swivel lever support H using a conventional pin 1;
a V seat, on a tilted support I, where placed is a bar 67 by way of “male-female engagement” system and on opposed end, aforementioned bar 67 has a conventional bicycle seat 68; said bar has at least two centered and equidistant holes 69 which in turn cross two of its faces and a conventional pin 1 is used to adjust height, by way of tilted stem 18;
a Resistance bands support E, which accounts for all those features as contained in fixed support A, nevertheless, in plate A2 there is a fixed semicircular arch 6, over which other conventional accessories are attached, such as resistance bands, ropes, etc.;

9. The structure of claim 1 comprising:
a Fixed support A, which consists of a set of three plates, A1, A2, A3 that are continuously arranged forming a square “U” since the end of the first A1 continues with the start of the second A2, creating 90° angles and the third A3, is located at the end of the second, thus creating the same angle; the first A1 and the third A3 plates, located at opposite ends to plate A2 in respective centered side surface, incorporate at least one hole A4, through which a pin 1 goes through; furthermore, over plate A2 located are: other supports (vertical D or horizontal F) or those accessories to which implemented is fixed support A;
a Swivel support B, which accounts for the same features as fixed support A, nevertheless plate A2 incorporates a pivot 2 over which accessories that are placed in swivel support B spin. In turn, aforementioned pivot has a threaded hole 3.
a Support with stops C, which accounts for the same features as swivel support B, nevertheless, in plate A2 there is at least one stop 4, where upon accessories being spun using pivot 2 and plate A2, there is at least one hole 5 which in turn allows using a second pin 1 in order to secure the same accessory as used by described support;
a Vertical support D, which accounts for all those features contained in fixed support A, nevertheless, in plate A2 there is a perpendicular stem 7 fixed to said plate, and on stem 7 opposite end there is at least one hole 8 on each face;
a Horizontal support F, which accounts for all those features as contained in fixed support A, nevertheless, in plate A2 there is a horizontal stem 9 fixed to said plate and has at least one pass-through hole 10 on vertical opposed faces and at least one pass-through hole 11 on parallel face to plate A2;
a Fixed support K which accounts for all those features as contained in fixed support A, nevertheless, in plate A2 there are two holes K4, one on each end to plate A2; and
a Resistance bands support E, which accounts for all those features as contained in fixed support A, nevertheless, in plate A2 there is a fixed semicircular arch 6, over which other conventional accessories are attached, such as resistance bands, ropes, etc.
